(19) United States
(12) Patent Application Publication
(10) Pub. No.: US 2005/0058100 A1
(43) Pub. Date: Mar. 17, 2005

(54) Method for optimizing nested tunnels using nested path information in a mobile network

(75) Inventors: Sung-Jin Lee, Suwon-si (KR); Hyun-Jeong Kang, Seoul (KR); Jong-Keun Na, Seongnam-si (KR); Seong-Ho Cho, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/941,740

(22) Filed: Sep. 15, 2004

(30) Foreign Application Priority Data
Sep. 15, 2003 (KR) 2003-63570

(51) Int. Cl. H04Q 7/00

(52) U.S. Cl. 370/331

(57) ABSTRACT

A method for optimizing a tunnel between a second mobile router and a home agent of the second mobile router in a mobile network having a nested structure in which a first mobile router manages a subnetwork including at least the second mobile router. The second mobile router manages a subnetwork including at least one node. The second mobile router receives nested path information from the first mobile router. The second mobile router transmits the nested path information to the home agent of the second mobile router via the first mobile router. The home agent of the second mobile router stores the nested path information received from the second mobile router thereby performing tunneling with the second mobile router.

### PRIORITY

This application claims priority under 35 U.S.C. § 119 to an application entitled “Method for Optimizing Nested Tunnels Using Nested Path Information in a Mobile Network” filed in the Korean Intellectual Property Office on Sep. 15, 2003 and assigned Serial No. 2003-63570, the contents of which are incorporated herein by reference.

### BACKGROUND OF THE INVENTION

1. Field of the Invention

The present invention relates generally to Mobile Internet Protocol version 6 (MIPv6) proposed to support host mobility in Internet Protocol version 6 (IPv6), a next generation Internet protocol, and in particular, to a method for optimizing a complicated transmission path that is nested due to mobile routers simultaneously existing in the same network.

2. Description of the Related Art

Currently, with the wide spread use of Internet Protocol (IP) networks, even a wired section of a cellular network is evolving into the IP network, and as such, computers developed only for a wired environment are required to provide services while maintaining seamless continuity in a high-speed wireless environment.

In the existing Internet environment, because only the wired environment is considered, an IP address is assigned to a terminal only once, and the terminal maintains a connection using the assigned IP address. That is, possible movement of the terminal is not considered in the existing Internet environment. However, as the IP network is used even in a wired section of a mobile network and the terminal has a data communication function as well as a voice call function, in some cases, the terminal using an IP address to which it must transmit data may move to another place.

In order for a terminal assigned a fixed IP address to normally transmit data while on the move, a home network (HN) must continuously trace a position of the terminal and store the position information as a position of the terminal is changed. The HN is a network in which the terminal is first assigned an IP address and then registered.

In order to satisfy the requirement above, a Mobile IP has been developed for fundamentally supporting the mobility of an IP terminal and providing a function for tracing and storing position information.

Transport Control Protocol/Internet Protocol (TCP/IP), a standard protocol for providing Internet communication over computers, uses a plurality of layers like other network protocols. Commonly, this is called protocol stack, protocol suite, or protocol structure.

The TCP/IP protocol stack is based on two important protocols of TCP and IP, and the IP protocol, a protocol corresponding to Open Systems Interconnection (OSI) Layer 3, is mainly used for the current Internet Protocol version 4 (IPv4) and selects a path for tracking connection of physical sub-networkings and a destination of an IP address.

Accordingly, the IP protocol is used to assign transmission addresses and reception addresses for many terminals or nodes (i.e., devices for implementing the IP protocol), which are connected to the Internet. The current Internetwork Layer communicates between hosts in a network using 32-bit IP addresses. The IP address is used distinguish a particular node using a network IP and a node IP (or host IP).

Because the rapid increase in the number of Internet users, the IPv4 protocol suffers from lack of available resources, mobility, and security. Accordingly, IP version 6 (IPv6), a new protocol for solving such a problem, has been developed. The IPv6 protocol, also known as Internet Protocol next generation (IPng), is disclosed in the Request for Comments (RFC) 2460 draft standard.

The IPv6 protocol can solve some of the above problems by extending a length of IP addresses from the existing 23 bits to 128 bits, and can also enable real-time processing of multimedia data. Further, the IPv6 protocol is advantageous in that it can reinforce a security function by installing IP Security Protocol (IPsec) therein, solving the problem in the IPv4 protocol that the IPsec protocol, a patch-type protocol, must be separately installed for a security function.

However, because the IPv6 protocol is different from the IPv4 protocol in header structure, compatibility between the two protocols is not provided. Therefore, it is expected that in the future, IPv4 networks will be gradually replaced with IPv6 networks or networks supporting both IPv4 and IPv6.

Table 1 illustrates a structure of a standard protocol for application of IPv6.

TABLE 1

| | Layer |
|---|---|
| Application Layer | Application |
| Transport Layer | TCP/UDP |
| | IPv6 |
| Physical Layer | Physical |

Referring to Table 1, a TCP/IP standard protocol for application of IPv6 includes an Application Layer, a Transport Layer having a Transport Control Protocol/User Datagram Protocol (TCP/UDP), and an Internetwork Layer implemented with IPv6 (or Internet Control Message Protocol for IPv6 (ICMPv6)), and a Physical Layer.

IPv6 datagram, like IPv4, includes a header and a payload. The payload is used to forward data to be transmitted between two hosts. The IPv6 header has a fixed size of 40 bytes, and does not have a header checksum field, which caused a considerable bottleneck in the IPv4.

The IPv6 protocol has a header structure for mobility support, security support, and quality guarantee of multimedia applications, which are not available in the IPv4 protocol. For example, a header of the IPv6 standard protocol includes, as basic header fields, a 4-bit version field, an 8-bit traffic class field, a 20-bit flow label field related to quality-of-service (QoS), a 16-bit unsigned integer payload length field representing a length of contents, an 8-bit next header (NH) field defining a type of a next header following an IPv6 header, an 8-bit unsigned integer hop field that decreases by 1 at each node forwarding packet, a 128-bit source address field representing an address of a packet sender, and a 128-bit destination address field representing an address of a packet recipient.

In addition, an extended header field includes a hop-by-hop option field, a destination option header, a routing header, a fragment header, an authentication header, and an Encapsulating Security Payload (ESP) header.

The IPv6 standard protocol is implemented by software in order to be used in an environment where personal computers (PCs) are mainly used. Commonly, the IPv6 standard protocol is processed by operating systems such as Windows, Linux, and Real-time OS.

FIG. 1 is a diagram illustrating a fundamental network configuration for Mobile IPv6. Referring to FIG. 1, the elements using the Mobile IPv6 include mobile nodes (MNs), home agents (HAs), and routers. In addition, the Mobile IPv6 network includes a home network (HN), an Internet network, and foreign network (FN).

Referring to FIG. 1, MNs 110 and 170 are mobile nodes performing packet data communication using mobile IPs assigned thereto. Further, because the MNs 110 and 170 are operating within Mobile IPv6 network, the MNs 110 and 170 can move within the wireless environment. An HN 100 is a network in which the MNs 110 and 170 are first registered, and an HA 120 is a router of the HN 100 for relaying the HN 100 to another network. The HA 120 manages registration information of the MNs 110 and 170.

In FIG. 1, the MN 170 moves from the HN 100 to a new network, i.e., FN140. That is, in FIG. 1, because the MN 170 has moved from the HN 100 to the FN 140, a network where the MN 170 is currently located becomes the FN 140.

When the MN 170, which was located in the HN 100, enters the FN 140, the MN 170 cannot use the IP address initially assigned in the HN 100. Therefore, the FN 140 assigns a new temporary IP address, or Care-of-Address (CoA), available in the FN 140 to the MN 170.

IP in the current Mobile IPv6 environment is assigned a total of 128 bits as described above. Further, among the 128 bits, higher bits are designated as a prefix for identifying a network and lower bits are designated address uniquely assigned to each mobile node. Therefore, when the MN 170 moves from the HN 100 to the FN 140 as described above, a router 150 of the FN 140 analyzes unique address information in an IP address of the MN 170 and determines that the MN 170 is a mobile node that has moved from another network to the FN 140. In this case, the router 150 of the FN 140 analyzes a prefix in the IP of the mobile node and generates a new unique address according to a predetermined rule.

Further, the router 150 determines if a duplicate address is generated in the new-address generation process. That is, when the MN 170 enters a new network, it is assigned CoA, i.e., a temporary IP address, in addition to an IP address assigned in the HN 100, and the MN 170 transmits and receives data using the assigned CoA while it is located in the new network (i.e., FN 140).

Although the MN 170 has moved to the new network, i.e., FN 140, all data targeting the MN 170 is transmitted to the old network, i.e., HN 100, in which the MN 170 was first registered. Therefore, in order for the MN 170 to receive data, the MN 170 must provide its location information to the HA 120.

Accordingly, when the MN 170 enters the FN 140 and is assigned a new CoA, the router 150 of the FN 140 binds CoA information of the MN 170 with the IP address used by the MN 170 in the HN 100 and transmits the binding result to the HA 120 via an Internet network 130 using a Binding Update (BU) message 180.

The HA 120 receives the BU message, analyzes the received BU message, matches the IP address used in the HN 100 by the MN 170 with the CoA assigned in the FN 140, and stores the matching result in a predetermined table. Thereafter, the HA 120 intercepts all packets targeting a home IP address of the MN 170, i.e., a network address of the HN 100, as a destination address, and transmits the intercepted packets to the FN 140.

More specifically, the HA 120 searches the table for CoA of the MN 170, determining that the received packets are targeting the MN 170. Thereafter, the HA 120 adds a header to the packets by encapsulation, sets a destination address of the packets to a CoA address of the MN 170, and transmits the packets up to the MN 170 (see arrow 185). Because all data packets targeting the MN 170, received at the HA 120, are transmitted to the FN 140 in the procedure described above, the HN 120 and the FN 140 undergo “tunneling” for the MN 170.

However, as a mobile network environment undergoes such complicated changes, the mobile network environment requires additional functions. That is, as communication technology gradually evolves into advanced communication technology supporting various wireless Internet environments, there is provided a complicated network configuration in which one network has small networks and each of the small networks has smaller networks.

For example, in some cases, a small unit network such as a personal area network (PAN) or an intelligent transportation system (ITS), in which a wireless Internet apparatus is installed in a vehicle to provide an Internet access service to passengers, moves. In this case, the conventional Mobile IP technology has limitations in providing services, thereby causing drops of packet transmission. In order to solve this problem, Internet Engineering Task Force (IETF), an Internet standardization organization, has newly organized Network Mobility (NEMO) Working Group (WG) to independently study NEMO technology, which was under standardization in the existing Mobile IP WG.

FIG. 2 is a diagram illustrating a conventional network configuration using a NEMO Basic Support Protocol. Referring to FIG. 2, the NEMO Basic Support Protocol supports transparent network mobility to all mobile nodes (MNs) in a mobile network (MONET) based on bi-directional tunneling (260 and 270) between each mobile router (MR) and an HA.

The MR in the MONET control mobility management of the network, and when the MR moves from an HN 200 or 215 to an FN 230, it registers its own location information and a mobile network prefix (MNP) used in the MONET in an MR1_HA 205 located in the HN 200 or 215. In addition, during the location registration, the MR performs prefix scope binding update (PSBU) having a concept extended from MIPv6.

For convenience, in the present application, an HA of a particular MR, in which the MR is first registered, will be represented by “MR_HA.” Therefore, in FIG. 2, an HA of the MR1 210 corresponds to MR1_HA 205, and an HA of an MR2 225 corresponds to MR2-HA 220.

As described above, the MR1_HA 205 and the MR2_HA 220 store information on the MR1 210 and information on the MR2 225, respectively, and CoAs that the MRs are assigned each time they move are stored in a table. That is, when a particular MR enters a new network (i.e., an FN) and is assigned CoA, the assigned CoA will be represented as “MR_CoA.”

When the MR1 210 moves to the FN 230 and an MR1 240 moved to the FN 230 is assigned CoA from the FN 230 in FIG. 2, packets are transmitted from a correspondent node (CN) 280 to an MN2 managed by the MR1 240. Because the CN 280 stores a home IP address of the MR1 210, the CN 280 uses an address of the MN2 as a destination address during packet transmission. Further, because the transmitted packets use a home IP address of the MN2 as a destination address, the packets are forwarded to the HN 200 of the MR1 210 by routing in an Internet network.

The HA of the MR1, or MR1_HA 205, receives packets through the Internet routing, and acquires CoA for a point to which the MONET is currently connected from information registered in a binding cache (BC) by intercepting packets whose MNP is identical to MNP of the MN2. Thereafter, the MR1_HA 205 tunnels the intercepted packets through a bi-directional tunnel 260 between the MR1 240 and the MR1_HA 205 based on the acquired CoA of the MR1 240. The tunneled packets are encapsulated such that a sender's address becomes the MR1_HA 205 and a destination address becomes CoA of the MR1 240 (i.e., MR1_CoA). The encapsulated packets are routed (or transmitted) to the MR1 240 via the Internet network and a router 235 of the FN 230 through the tunneling path. The MR1 240, an end point of the tunnel, receives the tunneled packets, decapsulates the received packets, and then forwards the decapsulated packets to the MN2, i.e., the final destination in the network.

A description will now be made of a process of transmitting packets forwarded from an MN1 to the CN 280 in FIG. 2. The MR1 240 encapsulates packets forwarded from an ingress interface, and forwards encapsulated packets through the tunnel 260 established between the MR1 240 and the MR1_HA 205. A source address of the encapsulated packets becomes CoA of the MR1 240 (i.e., MR1_CoA), and a destination address becomes an address of an HA registered in a binding update list (BUL). If the tunneled packets 265 arrive at the MR1_HA 205, the MR1_HA 205 decapsulates the corresponding packets and routes the decapsulated packets to the CN 280, the final destination.

In the NEMO Basic Support Protocol technology, after each of the MRs establishes a tunnel to its HA, the MR preferentially forwards packets from mobile nodes (MNs) connected to its subnetwork up to a corresponding HA through the established tunnel, and the packets are transmitted from the HA to an original destination (i.e., a CN) to which the MN desires to forward packets.

When the MONET exists in the original HN, packets are forwarded by general IPv6 routing. The HA determines if the MONET exists in the HN by maintaining a BC, and an entry registered in the BC becomes invalid when a BU message with lifetime=0 is received from the MR. That is, if it is determined that the MR has returned to the HN, the MR immediately transmits a BU message with the lifetime set to ‘0’ to the HA, indicating that it has returned to the original HN.

Additionally, the MR2 225 of FIG. 2 will be described herein below. The MR2 225 can move from its HN 215 to a new network (i.e., FN 230), and at this time, mobile nodes (MN3 and MN4) belonging to the MR2 225 also moves together. The MR2 245, after moving to the FN 230, is assigned a new CoA in the FN 230, and the assigned CoA information is transmitted to the MR2_HA 220, an HA of the MR2, using a BU message, thereby forming the tunnel 270 between the MR2 245 and the MR2_HA 220. As described above, packets 275 forwarded from the CN 280 to the MN3 or MN4 are intercepted by the MR2_HA 220 and then transmitted to the MR2 245 through the path 270 where the tunnel is formed. The MR2 245 receives the packets, and transmits the received packets to a corresponding MN, if the received packets target the MN (MN3 or MN4) managed by the MR2 245.

FIG. 3 is a diagram illustrating a conventional network configuration with a nested structure configured using the NEMO Basic Support Protocol. Referring to FIG. 3, in some cases, an MR2 335, another MR, may belong to an MR1 330 connected to a particular router 325. This situation corresponds to, for example, the PAN and ITS system described above. Assuming the MR2 335 is a mobile router included in a personal area network and the MR1 330 is a mobile router installed in a particular vehicle, the MR1 330 can move from its HN to an FN, or a new network, as the vehicle moves on, and the MR2 335 can belong to a coverage area (or service area) of the MR1 330 as it rides in the vehicle and moves from its HN to a new network. For example, MN1 and MN2 moving together with the MR1 330 may correspond to mobile communication devices installed in a vehicle, and MN3 and MN4 moving together with the MR2 335 may correspond to mobile communication devices carried by individuals.

In this situation, when the MN4 340 carried by an individual desires to communicate with a CN 360, a tunnel must be formed between MR2_HA 305 and an MR1_HA 300.

As described above, the NEMO Basic Support Protocol technology has a basic mechanism in which each of the MRs forms a tunnel to its HA and transmits/receives packets via the HA through the formed tunnel. Therefore, the MR1 330 forms a tunnel 350 to the MR1_HA 300, and the MR2 335 forms a tunnel 355 to the MR2_HA 305. However, because the MR2 335 is located in a subnetwork of the MR1 330, it must process packets such that the MR1 330 should transmit the packets from the MR2 335 via its MR1_HA 300. That is, a tunnel formed from the MR2 335 through the MR2_HA 305 must pass through the tunnel 350 between the MR1 330 and the MR1_HA 300. Therefore, as illustrated in FIG. 3, the tunnel 355 between the MR2 335 and the MR2_HA 305 passes through the tunnel 350, which is an unnecessary path, between the MR1 330 and the MR1_HA 300, forming a path. Accordingly, the increase in number of nested MRs increases the number of unnecessary paths.

FIG. 4 is a diagram illustrating a conventional network configured using the NEMO Basic Support Protocol, in which paths are inefficiently established through unnecessary nodes. For example, it is assumed in FIG. 4 that 3 MRs are nested on a threefold basis.

Referring to FIG. 4, when the MRs are nested on a threefold basis, one more MR is added to a higher-level network as compared with the case (see FIG. 3) where 2 MRs are nested. Therefore, packets must pass through one more tunnel, and paths are even more complicated.

In FIG. 4, an MR2 430 is connected to a subnetwork of an MR1 425 on a nested basis and a particular MN 440 or 445 is connected to a subnetwork of the MR2 430 via an MR3 435. A bi-directional tunnel exists between the MR1 425 and an MR1_HA 400, and a nested bi-directional tunnel between the MR2 430 and an MR2_HA 405 is formed in the tunnel between the MR1 425 and the MR1_HA 400. When the MN 440 or 445 connects with a link to the MR2 430 via the MR3 435 and transmits packets to a CN 420, the corresponding packets pass through the following three tunnels.
1. tunnel from the MR3 435 to the MR3_HA 410
2. tunnel from the MR2 430 to the MR2_HA 405
3. tunnel from the MR1 425 to the MR1_HA 400

As a result, the data to be transmitted from the MN 440 or 445 to the CN 420 is forwarded to the CN 420 via the MR3 435, MR2 430, MR1 425, MR1_HA 400, MR2_HA 405, MR3_HA 410, and MN_HA 415. The increase in number of nested MRs increases the number of formed tunnels, thereby complicating a packet transmission path and increasing a size of a header added to the packets.

FIG. 5 is a diagram illustrating a conventional tunnel formed between an MN to a CN. Referring to FIG. 5, a tunnel formed between an MN 560 to a CN 500 has a threefold nested structure. That is, packets transmitted from the MN 560 to the CN 500 pass through three tunnels, and additional information is added to the packets each time the packets pass through one tunnel. More specifically, for communication between the MN 560 and the CN 500, tunnels 510 and 550 are formed between an MR3 and an MR3_HA, tunnels 520 and 540 are formed between an MR2 and an MR2_HA, and a tunnel 530 is formed between an MR1 and an MR1_HA.

The tunnel section 530 between the MR1_HA and the MR1 has a structure in which 3 tunnels are nested, and in order to transmit one data packet, three headers are added to the packet unnecessarily. The added headers are not related to the transmission data packet, and become unnecessarily wasted information, i.e., overhead.

As described above, when nested tunnels are formed due to nested networks, transmission packets are transmitted up to the original destination through many unnecessary paths in the Internet network. Such a problem is known as a ‘dog-leg’ or ‘pinball’ routing problem. In this case, complicated inefficient routing paths are set up, thereby causing packet transmission delay. Although routing optimization technologies for solving such a problem have been proposed, a nested overhead problem remains unsolved and a security problem caused by the nested overhead problem also remains unsolved.

In the nested MONET structure, if the NEMO Basic Support Protocol based on bi-directional tunneling is used, the inefficient routing described in connection with FIGS. 3 and 4 occurs. The inefficient routing causes an increase in packet size due to nested encapsulation and tunneling, and also causes an overhead problem that a size of a header field necessary for data transmission is excessively larger than a size of actual transmission data. In addition, when HAs are geographically separated far away from each other, a packet transmission delay may occur. This is defined as a nested tunnel optimization problem in terms of routing optimization, and this problem must be resolved in order for serviceable mobility support.

Although the nested problem has been resolved to some extent, several previously proposed routing optimization methods are vulnerable in security. Consequently, if a fake MR is located in an intermediate path during packet transmission, the packets may be fatally forwarded to an unauthorized user.

### SUMMARY OF THE INVENTION

It is, therefore, an object of the present invention to provide a method for reducing a packet transmission delay by enabling transmission packets to be directly communicated with a CN without an unnecessary passing through intermediate paths, even when several MRs are nested.

It is another object of the present invention to provide a method for reducing an unnecessary overhead in a network by minimizing a packet transmission path.

It is further another object of the present invention to provide a method for maintaining security and information integrity by enabling an initial sender to generate and send MR list information, such that information in a packet cannot be manipulated, in a router and several nodes through which information on nested MRs is transmitted on a packet basis using an option field.

According to a first aspect of the present invention, there is provided a method for optimizing a tunnel between a second mobile router and a home agent of the second mobile router in a mobile network having a nested structure in which a first mobile router manages a subnetwork including at least the second mobile router. The second mobile router manages a subnetwork including at least one node. In the method, the second mobile router receives nested path information from the first mobile router. The second mobile router transmits the nested path information to the home agent of the second mobile router via the first mobile router. The home agent of the second mobile router stores the nested path information received from the second mobile router.

According to a second aspect of the present invention, there is provided a method for transmitting packet data from a second mobile router to a node located outside a first mobile router in a mobile network having a nested structure in which the first mobile router manages a subnetwork including at least the second mobile router. The second mobile router manages a subnetwork including at least one node. In the method, the second mobile router performs tunneling with a home agent of the second mobile router. The second mobile router adds a tunneling header including its nested path information to a transmission packet, and transmits the transmission packet to the first mobile router. The first mobile router receiving the packet transmitted from the second mobile router analyzes the nested path information in the received packet and transmits the packet to the home agent of the second mobile router.

According to a third aspect of the present invention, there is provided a method for transmitting packet data from a node located outside a first mobile router to a second mobile router in a mobile network having a nested structure in which the first mobile router manages a subnetwork including at least the second mobile router. The second mobile router manages a subnetwork including at least one node. In the method, the second mobile router performs tunneling with a home agent of the second mobile router. The home agent receives packet data from a node located outside the first mobile router, analyzes nested path information from the second mobile router stored in the home agent of the second mobile router, adds a tunneling header including nested path information from the second mobile router to a transmission packet, and transmits the transmission packet to the first mobile router. The first mobile router receives a packet transmitted from the home agent of the second mobile router, analyzes nest path information in a header of the received packet, and transmits the packet to the second mobile router.

### BRIEF DESCRIPTION OF THE DRAWINGS

The above and other objects, features, and advantages of the present invention will become more apparent from the following detailed description when taken in conjunction with the accompanying drawings in which:

FIG. 1 is a diagram illustrating a fundamental network configuration for Mobile IPv6;

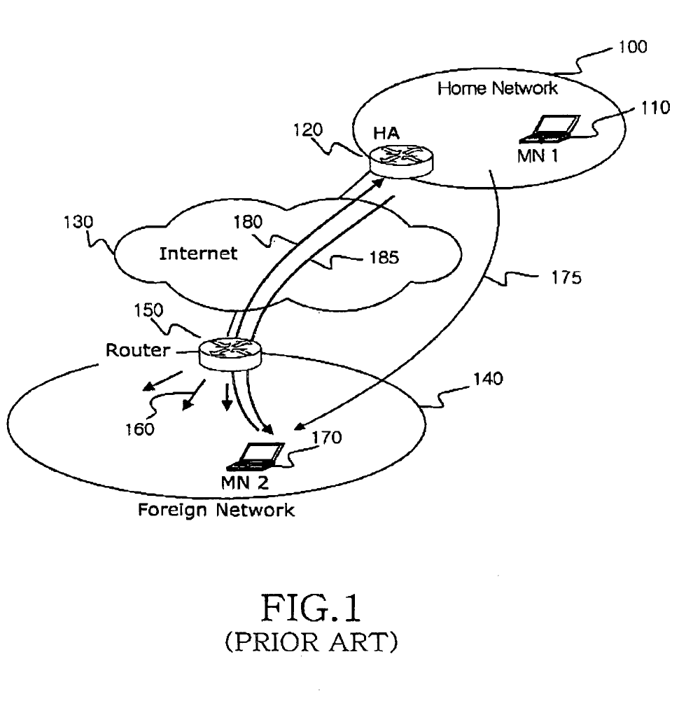

FIG. 2 is a diagram illustrating a conventional network configuration using NEMO Basic Support Protocol;

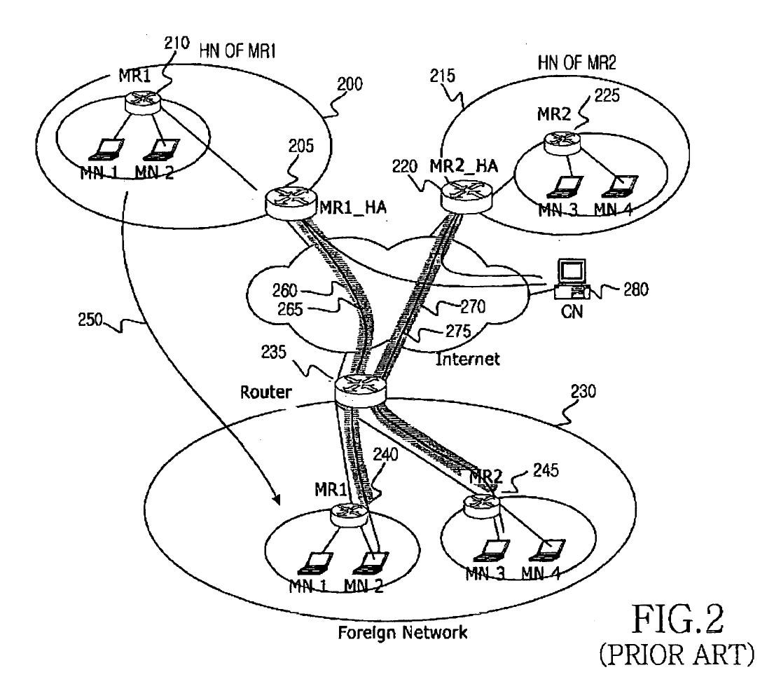

FIG. 3 is a diagram illustrating a conventional network configuration with a nested structure configured using NEMO Basic Support Protocol;

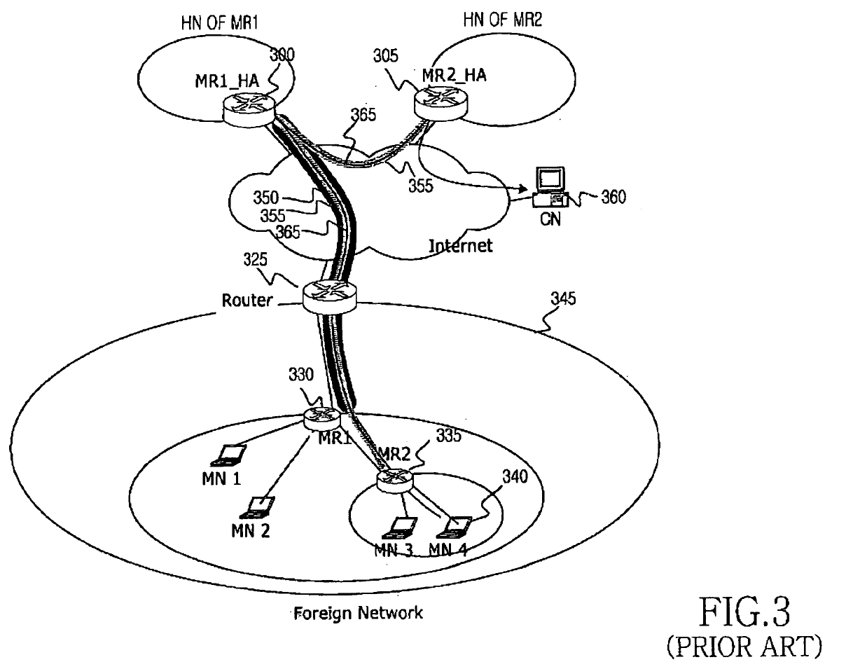

FIG. 4 is a diagram illustrating a conventional network configured using NEMO Basic Support Protocol, in which paths are inefficiently established through unnecessary nodes;

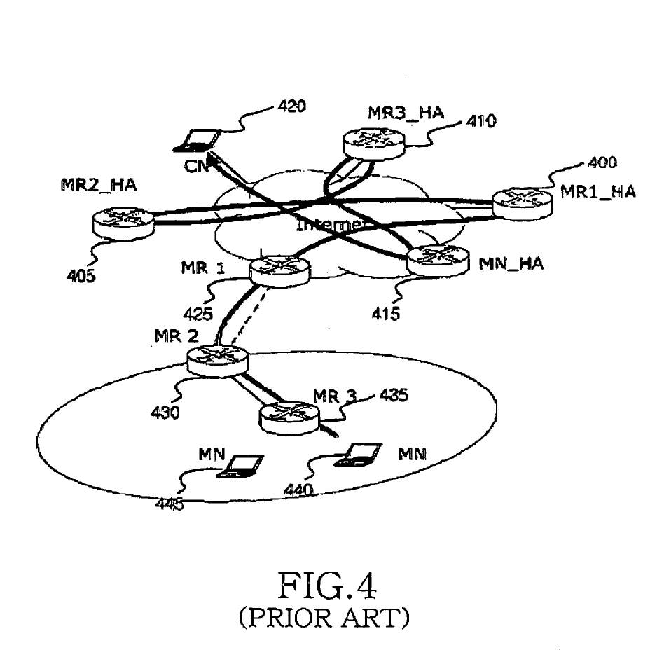

FIG. 5 is a diagram illustrating a conventional tunnel formed between an MN to a CN;

FIG. 6 is a network configuration diagram illustrating a process for registering nested path information according to an embodiment of the present invention;

FIG. 7 is a diagram illustrating a tunneling result by routing optimization according to an embodiment of the present invention;

FIG. 8 is a diagram illustrating a tunnel formed between an MN to a CN according to an embodiment of the present invention;

FIG. 9 is a diagram illustrating a format of a packet transmitted from an MR3 to an MR2 according to an embodiment of the present invention;

FIG. 10 is a diagram illustrating a format of a packet transmitted from an MR2 to an MR1 according to an embodiment of the present invention;

FIG. 11 is a diagram illustrating a format of a packet transmitted from an MR1 to an MR3_HA according to an embodiment of the present invention;

FIG. 12 is a diagram illustrating a format of a packet transmitted from an MR3_HA to an MR1 according to an embodiment of the present invention;

FIG. 13 is a diagram illustrating a format of a packet transmitted from an MR1 to an MR2 according to an embodiment of the present invention;

FIG. 14 is a diagram illustrating a format of a packet transmitted from an MR2 to an MR3 according to an embodiment of the present invention;

FIG. 15 is a diagram schematically illustrating a format of an RA message transmitted by an MR to its subnetwork according to an embodiment of the present invention;

FIG. 16 is a diagram schematically illustrating a format of an NRP option message in a BU message transmitted by an MR according to an embodiment of the present invention;

FIG. 17 is a flowchart illustrating a procedure for generating NPI list information by an MR according to an embodiment of the present invention; and

FIG. 18 is a flowchart illustrating a procedure for processing an NP option used for packet tunneling according to an embodiment of the present invention.

### DETAILED DESCRIPTION OF THE PREFERRED EMBODIMENT

Preferred embodiments of the present invention will now be described in detail herein below with reference to the annexed drawings. In the following description, a detailed description of known functions and configurations incorporated herein has been omitted for conciseness.

The present invention proposes a routing optimization (RO) method for solving an inefficient routing problem that occurs while supporting Mobile IPv6 (MIPv6) proposed to support host mobility (HOMO) in Internet Protocol version 6 (IPv6), NEMO Basic Support Protocol proposed to support network mobility (NEMO) based on MIPv6, and mobility.

MIPv6, which was developed to support mobility of a moving host using IPv6 (hereinafter referred to as an “IPv6 host”), can support mobility of a single host like the current mobile network. However, when a personal area network (PAN) and a small unit network installed in a vehicle (e.g., an ITS) simultaneously move, the MIPv6 has limitations in supporting mobility of the PAN and ITS. To solve this problem, Internet Engineering Task Force (IETF), an Internet standardization organization, has developed NEMO technology. However, as described above, the current NEMO technology has an inefficient routing structure in which data packets pass through an unnecessarily long path and many routers when mobile networks are nested.

However, when a first mobile router (MR) among MRs according to an embodiment of the present invention transmits a Router Advertisement message to its subnetwork together with information on a second MR nested in its higher level network, a third MR located in the subnetwork can recognize a nested structure of its mobile network where it is currently located, and perform a processing procedure thereon. That is, the third MR recognizes a nested network structure acquired through the Router Advertisement message and registers its location information together with information on a structure of its current network. As a result, the third MR can achieve routing optimization in which data can be transmitted and received through a simplified path without passing through the conventional inefficient routing path.

In addition, when the third MR previously generates nested network information and transmits the generated nested network information to a correspondent node (CN) with a single table, without modification in an intermediate node, integrity can be maintained by preventing the nested network information from being manipulated by an unauthorized (or fake) router among intermediate routers and nodes, such that the nested network information can be securely transmitted to the CN.

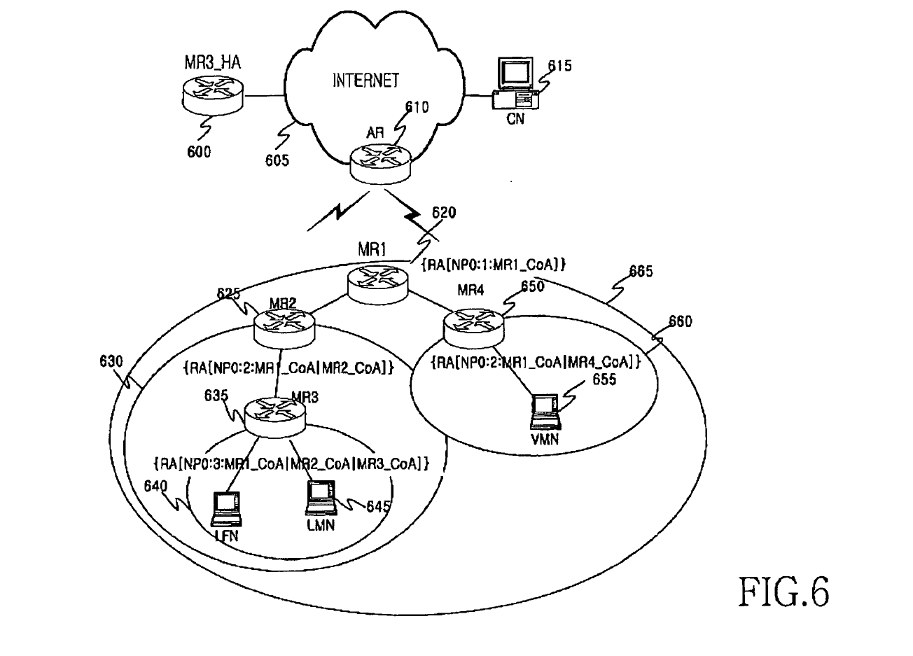

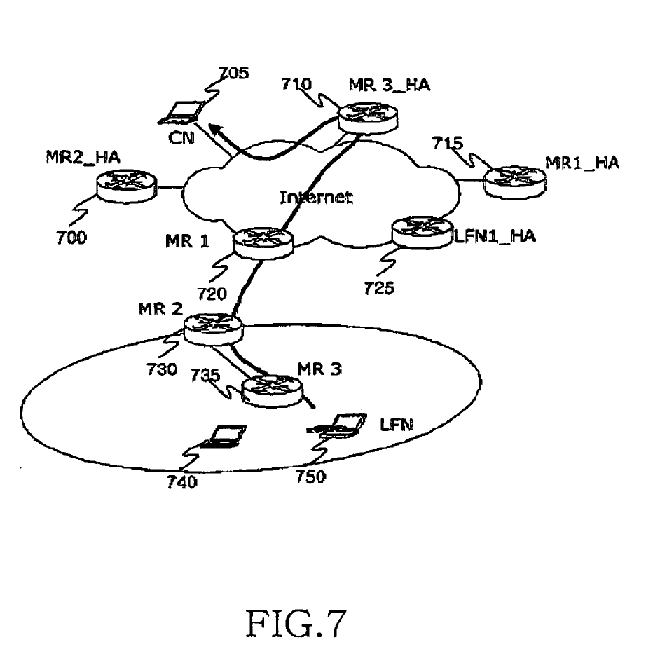

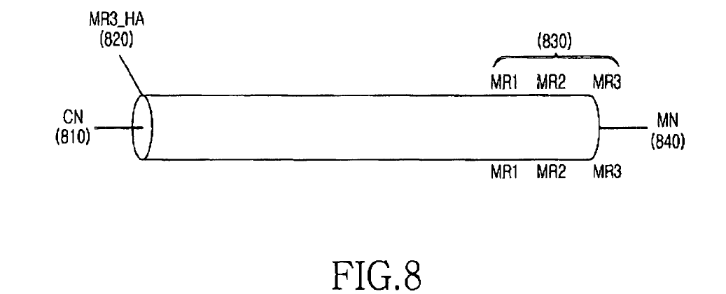

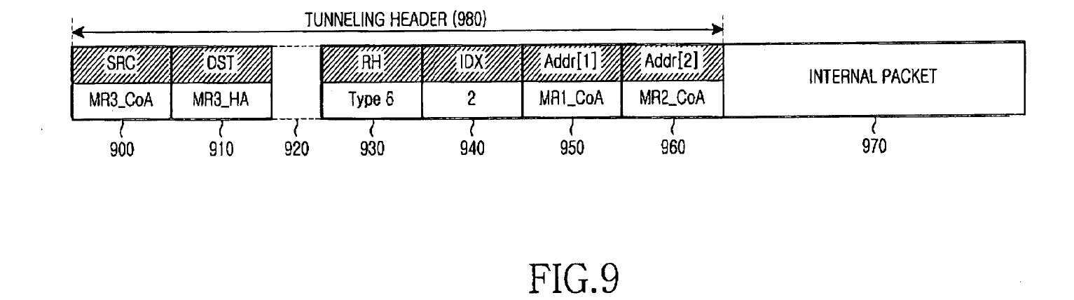

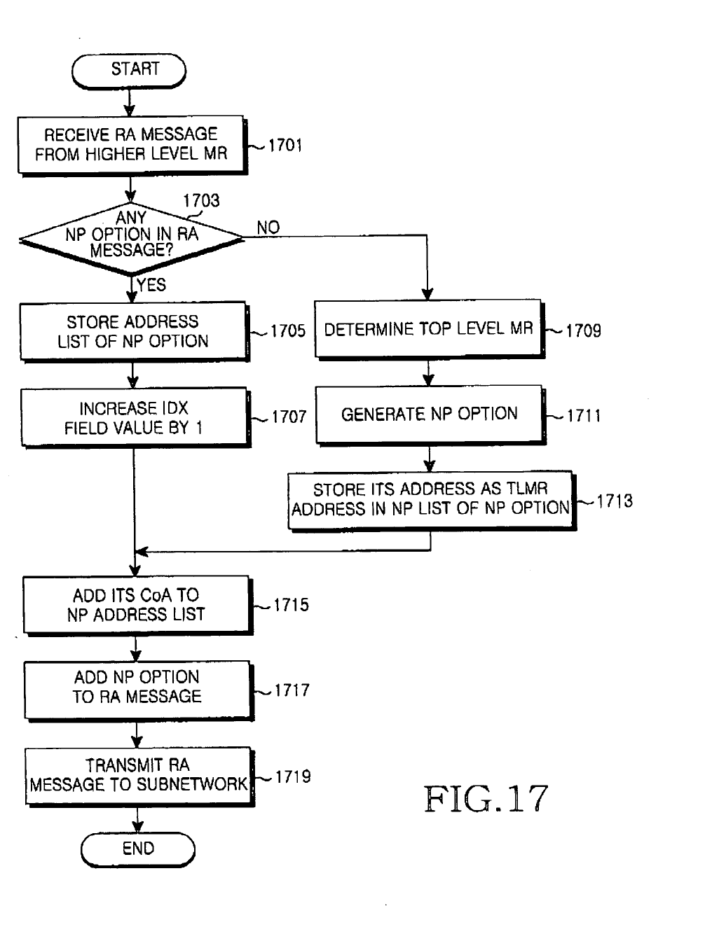

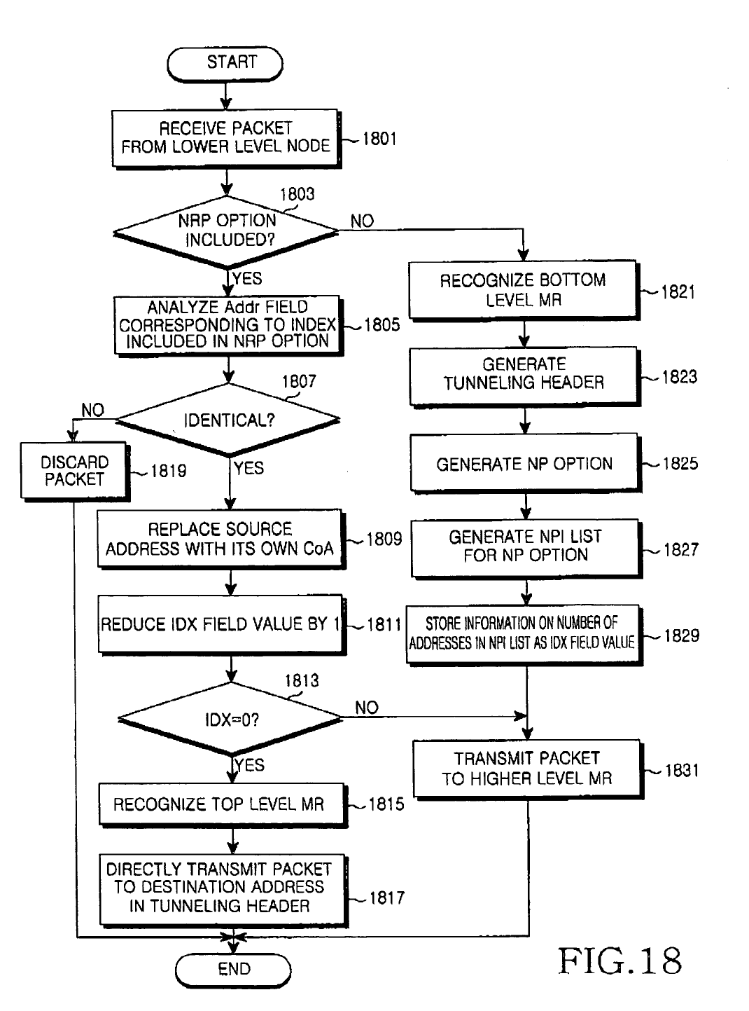

A detailed description of the present invention will now be made herein below with reference to the accompanying drawings. First, a method for transmitting nested MR information through a Router Advertisement message will be described with reference to FIG. 6. Thereafter, a tunneling structure in which the shortest path is established in the method of FIG. 6 will be described with reference to FIGS. 7 and 8. Further, a header format of a packet transmitted between nodes through a tunnel with the established shortest path will be described in detail with reference to FIGS. 9 to 16. Finally, a procedure for transmitting packets according to an embodiment of the present invention will be described with reference to FIGS. 17 and 18.

An optimized path tunneling process according to an embodiment of the present invention is divided into the following two processes.
A. Nested Path (NP) Detecting Process
B. Registration Process for Tunnel Optimization Using Nested Path Information (NPI)

In the nested path detection process, an MR located in the top level of a nested network transmits address information of MRs to its subnetwork, and a plurality of MRs located in the subnetwork and a plurality of mobile nodes (MNs) managed by each of the MRs acquire the nested path information. Further, in a tunnel optimization process using the nested path information, the MRs and the MNs report the acquired nested path information to an HA using a Nested Routing Path option, thereby establishing an optimized path. Thereafter, according to the optimized path tunneling process, packets are transmitted and received through the optimized tunnel established between an MN and a correspondent node (CN).

FIG. 6 is a network configuration diagram illustrating a process of transmitting nested MR information in a nested MONET according to an embodiment of the present invention. Referring to FIG. 6, an MR4 650 is a subnetwork of an MR1 620, and an MR3 635 is a subnetwork of the MR1 620 and an MR2 625. The MR4 650, which serves as an access router of the MONET, controls mobility management and performs the functions defined in the NEMO Basic Support Protocol.

A top level MR (TLMR) is an MR located in the top level in a nested mobile network, and is connected to a fixed network. A local fixed node (LFN) 640, which is included in a management area 640 of the MR3 635, is a fixed non-moveable node defined by classifying MNs according to their function. A local mobile node (LMN) 645 is a node that can move only in a corresponding mobile network (i.e., only in the same management area 640). A visiting mobile node (VMN) 655, which is included in a management area 660 of the MR4 650, is a visiting node that has moved from a domain having a different management area. That is, all of the LFN 640, the LMN 645 and the VMN 655 included in the MRs represent MNs, and are differently named according to their characteristics.

In FIG. 6, all MRs transmit a Router Advertisement (RA) message including a Nested Path (NP) option proposed in the present invention. A detailed format of the NP option will be described below with reference to FIG. 9. Therefore, among the MRs illustrated in FIG. 6, the MR2 625, the MR3 635, and the MR4 650, i.e., all but the MR1 620, have the NP option included in RA messages received from their higher level MRs. However, because the MR1 620 is located in the top level and a router possibly located in a higher level of the MR1 620 is not an MR, an RA message transmitted by the MR1 620 does not include the NP option.

If a received RA message does not include an NP option, the MR1 620 recognizes that it is currently located in the top level in the nested mobile network.

MR1 620, MR2 625, MR3 635, and MR4 650 multibroadcast RA messages including an NP option to their subnetworks. The MR2 625 receives the RA message and transmits an RA message including an NP option further including its address over its management area 630. An RA message that the MR3 635 has received includes the NP option, and the NP option includes addresses of the MR1 620 and the MR2 625. Therefore, by analyzing the NP option, the MR3 635 can acquire information indicating that there is the MR2 625 located in its higher level and the MR1 620 located in a higher level of the MR2 625.

Referring to FIG. 6, for example, the MR1 620 multibroadcasts information indicating that there is the MR1 620 having a temporary address MR1_CoA located in a higher level of the MR2 625 and MR4 650, to the MR2 625 and MR4 650 located in its subnetwork through an NP option message RA[NP0:1:MR1_CoA]. The MR2 625 and MR4 650 receive the NP option message and recognize that the MR1 620 has MR1_CoA located in their higher level. Here, ‘NP0:1’ indicates that the MR1 620 is the top level MR (TLMR). As indicated above, the CoA (Care-of-Address) is a temporary IP address assigned from an HA of a network to which a particular MN has moved.

The MR2 625 multibroadcasts its own temporary address MR2_CoA to nodes located in its subnetwork, and multibroadcasts a temporary IP address MR1_CoA of the MR1 620 located in its higher level based on the NP option received from the MR1 620. That is, the MR2 625 configures and multibroadcasts an NP option message RA[NP0:2:MR1_CoA|MR2_CoA]. Likewise, the MR4 650 transmits an NP option message RA[NP0:2:MR1_CoA|MR4_CoA] with an NP option including MR1_CoA to its subnodes.

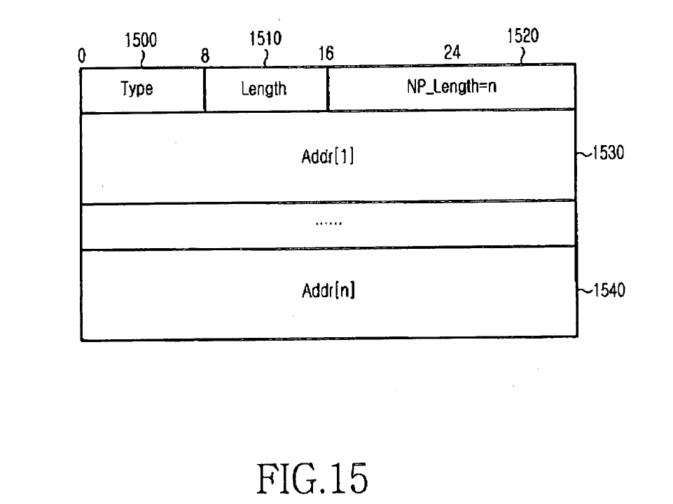

In the same method, the MR3 635 receives the NP option message from the MR2 625 and transmits a new NP option message including CoAs of the MR1 620 and the MR2 625 to its subnodes. That is, the MR3 635 transmits an NP option message RA[NP0:2:MR1_CoA|MR2_CoA|MR3_CoA]. The LFN 640 and LMN 645 included in the MR3 635 receive the NP option message, and recognize which MRs are located in their higher levels. The VMN 655, a subnode of the MR4 650, also receives the NP option message transmitted by the MR4 650, and determines which MRs are located in its higher levels. A format of the NP option will be described in more detail herein below with reference to FIG. 15.

The MR3 635, after detecting a nested path from the RA message through the NP option, transmits a location information registration message (i.e., BU message) to an MR3_HA 600 together with Nested Routing Path (NRP) option information for routing optimization. The NRP option information included in the BU message includes nested path information such as a temporary address MR1_CoA of the MR1 620, a temporary address MR2_CoA of the MR2 625, and a temporary address MR3_CoA of the MR3 635. The NRP option information is included in a plurality of address fields Addr[1] . . . Addr[n] before being transmitted, and an address of the top level MR is written in Addr[1] while an address of the bottom level MR is written in Addr[n].

The MR3_HA 600 receives the BU message including the NRP option information, stores only the nested path information in its BC entry, and creates a tunnel for routing optimization to the MR3 635. However, if routing optimization is not considered, a tunnel would be formed passing through all of the MR3 635, MR2 625, MR1 620, MR1_HA, MR2_HA, and MR3_HA 600 as described in the Related Art section. However, when routing optimization is performed according to the procedure proposed in the present invention, the tunnel is easily created in the form illustrated in FIG. 7.

FIG. 7 is a diagram illustrating a tunneling result by routing optimization according to an embodiment of the present invention. Referring to FIG. 7, by detecting a nested path in the above-described manner and transmitting corresponding nested path information to a corresponding HA, the nested path information is stored in a binding cache (BC) of the corresponding HA. Therefore, as illustrated in FIG. 7, a tunnel is formed, which passes through MR3 735, MR2 730, MR1 720, and MR3_HA 710, and transmission data of an LFN 750 is transmitted to the MR3_HA 710 via the tunnel of the formed optimized path, and finally transmitted from the MR3_HA 710 to a CN 705. That is, using the routing optimization according to the present invention, the transmission data skips the complicated path of LFN1_HA 725, MR1_HA 715, and MR2_HA 700 in the conventional tunnel.

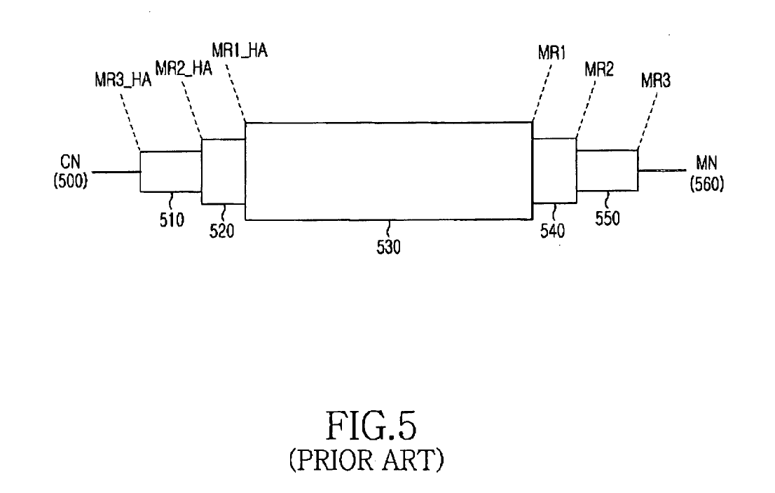

FIG. 8 is a diagram illustrating a tunnel formed between an MN to a CN according to an embodiment of the present invention. Referring to FIG. 8, because a corresponding HA previously knows nested information for its CoA through the NP option message, a new tunnel according to the present invention is different in structure from the conventional tunnel described with reference to FIG. 5. That is, because each node previously knows nested information 830 for MR1, MR2, and MR3 from an MN 840 to a CN 810, the node is not required to include unnecessary path information in a header during data transmission to the MR3_HA 830.

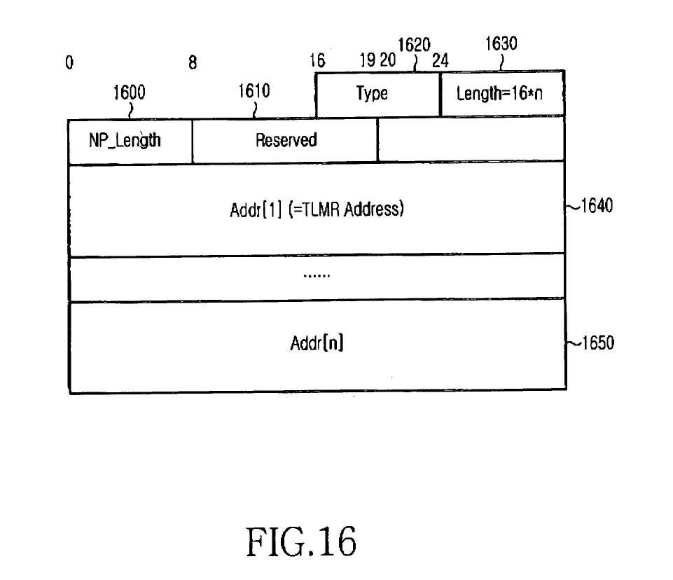

For example, because the MR3_HA 600 of FIG. 6 received a message including an NRP option from the MR3 635, it previously knows nested network information of a mobile network including MR3 635, MR2 625, and MR1 620. Therefore, because the MR3_HA 600 stores the reported nested path information and all intermediate HAs are skipped, an actual tunnel is formed from the MR3_HA 600 directly to the MR1 620, or the top level router (TLMR), among nested MRs. Through the BU message extended in this manner, a tunnel with an optimized path is formed between the MR3 635 and the MR3_HA 600. A format of the NRP option will be described in more detail herein below with reference to FIG. 16.

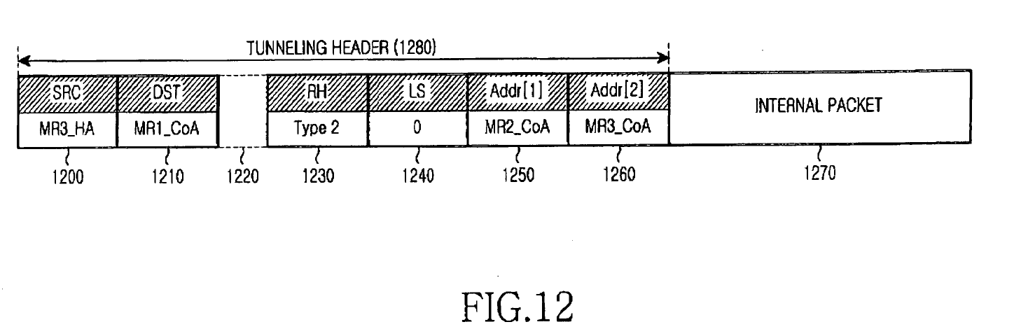

FIGS. 9, 10, and 11 are diagrams illustrating a format of packets transmitted from the MN 640 or 645 to the CN 600 through the optimized path according to an embodiment of the present invention. FIGS. 12, 13 and 14 are diagrams illustrating a format of packets transmitted from CN 615 to the MN 640 or 645 through the optimized path according to an embodiment of the present invention.

Reverse Packet Transmission Process (MN→CN)

Herein, among the headers inserted in packets exchanged between respective nodes, a tunneling-related header is called a ‘tunneling header’, and the tunneling header includes a source address field SRC, a destination address field DST, a message type field RH, an index field IDX, and first to N^{th} address fields Addr[1] to Addr[N]. The SRC field stores CoA of a transmission MR, and the DST field stores an HA address of the transmission MR. CoA information for a plurality of MRs located in a higher network of the MR is stored in the first to N^{th} address fields. Based on the IDX field, which indicates how many MRs are currently nested in higher levels, an address in one of the first to N^{th} address fields is used. The RH field includes information for determining whether the corresponding message is a transmission message or a reception message. Also, the RH field includes information indicating if a type of the message is identical to a message type defined in the present invention.

FIG. 9 is a diagram illustrating a format of a packet transmitted from the MR3 to the MR2 according to an embodiment of the present invention. Referring to FIG. 9, a tunneling header 980 inserted in a packet transmitted from the MR3 to the MR2 includes an SRC field 900, a DST field 910, an RH field 930, an IDX field 940, an Addr[1] field 950, and an Addr[2] field 960. MR3_CoA is written in the SRC field 900, and an MR3_HA address is written in the DST field 910. In addition, ‘Type 6’ is written in the RH field 930, and ‘2’ is written in the IDX field 940. Further, MR1_CoA is written in the Addr[1] field 950, and MR2_CoA is written in the Addr[2] field 960. The tunneling header 980 can further include a Reserved field 920 in addition to the above fields.

According to an embodiment of the present invention, because a source of the packet transmitted from the MR3 to the MR2 is the MR3, MR3_CoA is written in the SRC field 900, and because a destination immediately before the packet is transmitted to the CN is an MR3_HA, the MR3_HA address is written in the DST field 910.

The RH field 930 represents a method for determining a next target address of a packet based on an index indicated by a value of the IDX field 940 and routing the packet according to the determined address, and this method is defined as ‘Type 6’ in the present invention.

The MR3 is located in a subnetwork of the MR2, and the MR2 is located in a subnetwork of the MR1. Therefore, a temporary address MR1_CoA of the MR1, i.e., a top level MR (TLMR), is stored in the Addr[1] field 950, and a temporary address MR2_CoA of the MR2 located in the subnetwork of the MR1 is stored in the Addr[2] field 960. If a new MR exists between the MR2 and the MR3, an Add[3] field is further generated and CoA of the new MR is stored therein.

The MRs acquire nested information of their higher level MRs through NP options, and then write address information of the higher level MRs in the Addr[1] field 950 and the Addr[2] field 960 illustrated in FIG. 9 using the acquired information. Because the IDX field 940 indicates a next address to which a packet is to be forwarded while passing through the tunnel, if a value of the IDX field 940 is ‘2’, the packet is generated using Add[2] among the following Addr fields 960 and 960 as a next destination address.

The MR2, which receives the packet with the format illustrated in FIG. 9 transmitted from the MR3, detects the value ‘2’ stored in the IDX field 940, and compares data stored in the second address field Add[2] with its own address. In FIG. 9, because MR2_CoA stored in the Addr[2] is identical to its own temporary address, the MR2 transmits the packet to the MR1, or the top level MR, determining that the packet is a valid packet to be transmitted thereto.

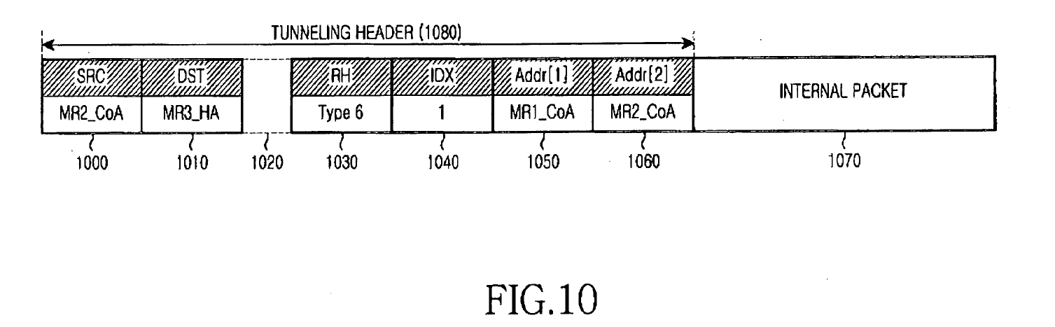

FIG. 10 is a diagram illustrating a format of a packet transmitted from the MR2 to the MR1, or a higher level MR of the MR2, according to an embodiment of the present invention. Referring to FIG. 10, a tunneling header 1080 inserted in a packet transmitted from the MR2 to the MR1 includes the same fields as those of the tunneling header 980 illustrated in FIG. 9. MR2_CoA is written in an SRC field 1000, and an MR3_HA address of the MR3_HA is written in a DST field 1010. In addition, ‘Type 6’ is written in an RH field 1030, and ‘1’ is written in an IDX field 1040. Further, MR1_CoA is written in an Addr[1] field 1050, and MR2_CoA is written in an Addr[2] field 1060. The tunneling header 1080 can further include a Reserved field 1020 in addition to the above fields.

According to the embodiment of the present invention, because a source of the packet transmitted from the MR2 to the MR1 is the MR2, MR2_CoA is written in the SRC field 1000, and because a destination immediately before the packet is transmitted to the CN is an MR3_HA, the MR3_HA address is written in the DST field 1010.

The RH field 1030 represents a method for determining a next target address of a packet based on an index indicated by a value of the IDX field 1040 and routing the packet according to the determined address. As described above, this method is defined as ‘Type 6’ in the present invention.

The address fields 1050 and 1060 are identical in structure to those in the tunneling header transmitted from the MR3. Because the MR3 is located in a subnetwork of the MR2, which is a subnetwork of the MR1, a temporary address MR1_CoA of the MR1, the top level MR (TLMR), is stored in the Addr[1] field 1050, and a temporary address MR2_CoA of the MR2 located in the subnetwork of the MR1 is stored in the Addr[2] field 1060.

The MR1 receives the packet with the format illustrated in FIG. 10 transmitted from the MR2, detects the value ‘1’ stored in the IDX field 1040, and compares data stored in the second address field Add[1] with its own address. In FIG. 10, because MR1_CoA stored in the Addr[1] is identical to its own temporary address, the MR1 transmits the packet to its higher-level MR, determining that the packet is a valid packet transmitted thereto.

The Addr fields 1050 and 1060 remain unchanged as created by the MR3 that first generated the packet. However, a value of the IDX field 1040 has decreased by 1. If the RH field 1030 with Type 6 is included in the received packet, the MR2 does not apply the conventional tunneling, and if an address of an index indicated by the IDX field 1040 is identical to its own address, the MR2 changes a source address of the packet to its own address, reduces a value of the IDX field by 1, and forwards the packet to the MR1, i.e., the next node. If the indexed address is not identical to its own address, the MR2 discards the corresponding packet and forwards a new packet to the MR1.

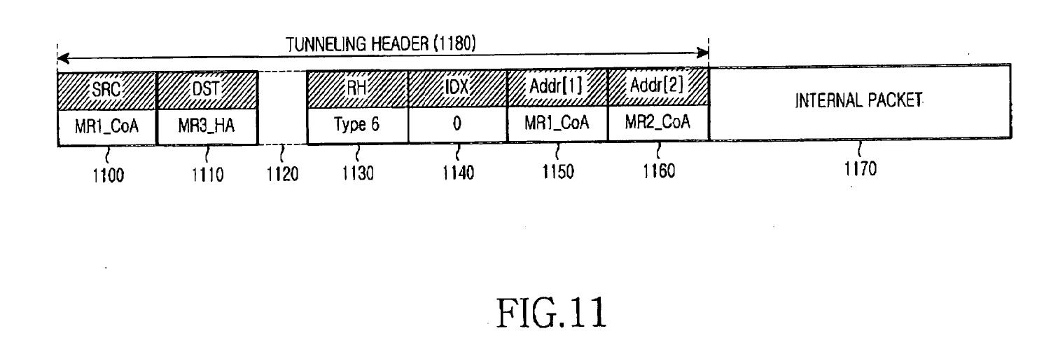

FIG. 11 is a diagram illustrating a format of a packet transmitted from the MR1, or the top level MR, to the MR3_HA according to an embodiment of the present invention. Referring to FIG. 11, because a DST field 1110 of a packet transmitted from the MR1 to the MR3_HA indicates the MR3_HA, a packet that arrives at the MR1, i.e., the top level MR, is directly transmitted from the MR1 to the MR3_HA without passing through the intermediate MR2_HA or MR1_HA.

The MR3_HA receives the packet with the format illustrated in FIG. 11 transmitted from the MR1, analyzes an RH field 1130 with an header option of Type 6 in the received packet, and searches a tunnel table to determine if there is a tunnel using a nested path with TLMR whose address is identical to the source address. If there is a tunnel to which the nested path is applied and a BU message from a corresponding tunnel is valid, the MR3_HA processes the received packet in the same way as the packet received from a tunnel formed between the MR3 and the MR3_HA, before transmission.

The MR3_HA receives the packet message illustrated in FIG. 11 from the MR1, stores information on Addr fields 1150 and 1160 of the received packet, and then immediately establishes a tunnel to the MR1 that transmitted the message to the MR3_HA.

Forward Packet Transmission Process (CN→MN)

In a transmission section from a CN to an MR3_HA, a packet generated in the CN is transmitted using a temporary address MN_CoA of an MN as its destination address. Because the MN is currently connected to a subnetwork of the MR3, it uses CoA based on prefix information of the MR3_HA as a temporary access of the MR1. Therefore, when a packet is transmitted using a temporary address MN_CoA of the MN as its destination address, the packet is transmitted to the MR3_HA.

The MR3_HA receives the packet transmitted from the MN and determines an IP address for the MN from the received packet. In this case, the MR3_HA determines through a BC table that CoA, MR3_CoA, of the MN is in an area of the MR3 located in a subnetwork of the MR2 located in a subnetwork of the MR1. The MR3 receives the packet transmitted from the MN corresponding to the MR3_CoA, and inserts a tunneling header in the received packet as illustrated in FIG. 12, before transmission.

FIG. 12 is a diagram illustrating a format of a packet transmitted from an MR3_HA to an MR1 according to an embodiment of the present invention. Referring to FIG. 12, an MR3_HA, receiving a packet transmitted from a CN to an MN, generates a tunneling packet and transmits the generated tunneling packet to an MR1. In FIG. 12, an internal packet 1270 corresponds to an original packet received from the CN, and a tunneling header 1280 corresponds to a header additionally attached to the head of a packet to tunnel the internal packet 1270.

In the tunneling header 1280 of a packet transmitted to the MR1_CoA by the MR3_HA, an MR3_HA address is written in an SRC field 1200 and an MR1_CoA address is written in a DST field 1210. In addition, an RH field 1230 is set to Type 2, and ‘0’ is written in a left segment (LS) field 1240. Further, MR2_CoA is stored in an Addr[1] field and MR3_CoA is stored in an Addr[2] field. Here, the LS field 1240 is identical in function to the IDX field.

The MR1 receives the packet illustrated in FIG. 12, analyzes a destination of the received packet, and determines that the packet targets the MR1 itself. Here, because the SRC field 1200 indicates MR3_HA, the MR1 recognizes that the packet should be transmitted to the MR3_CoA.

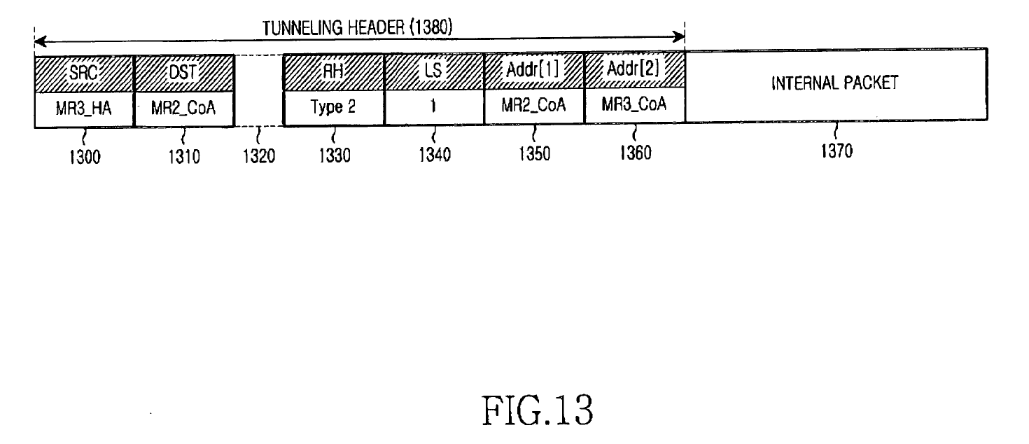

In order to transmit the received packet to the MR3_CoA, the MR1 generates again a packet with a format illustrated in FIG. 13 and transmits the generated packet to MR2_CoA in its subnetwork.

FIG. 13 is a diagram illustrating a format of a packet transmitted from an MR1 to an MR2 according to an embodiment of the present invention. More specifically, FIG. 13 illustrates a format of a packet modified to tunnel again the tunneled packet with the format illustrated in FIG. 12 received from the MR3_HA to the MR2 by the MR1. The MR1 receives a packet with the format illustrated in FIG. 12, writes MR2_CoA stored in the Addr[1] field 1250 indicating a top level address in an Addr list of the received packet, in a DST field 1310 indicating the next destination address, and tunnels the generated packet with the format illustrated in FIG. 13 to the MR2. An SRC field 1300 of a packet transmitted from the MR1 to the MR2 is fixed to MR3_HA, and an address of the DST field 1310 is replaced with the MR2_CoA as described above. In addition, Type 2 in an RH field 1330 remains unchanged, and an LS field 1340 increases by 1. Further, an Addr[1] field 1350 and an Addr[2] field 1360 remain unchanged.

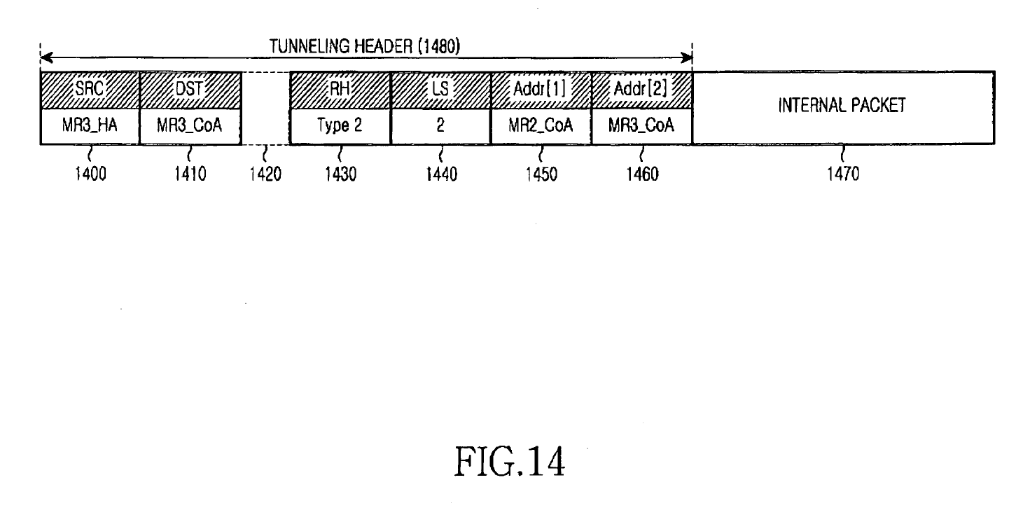

The MR2 receives a packet with the format illustrated in FIG. 13 from the MR1, detects MR2_CoA stored in the DST field 1310 of the received packet, and determines that the received packet is a packet targeting the MR2 itself. After determining that the received packet is a packet targeting the MR2 itself, the MR2 generates a packet with a format illustrated in FIG. 14, and transmits the generated packet to an MR3, a router located in its subnetwork.

FIG. 14 is a diagram illustrating a format of a packet transmitted from an MR2 to an MR3 according to an embodiment of the present invention. More specifically, FIG. 14 illustrates a format of a packet modified to tunnel again the tunneled packet with the format illustrated in FIG. 13 received from the MR1 to the MR3 by the MR2. The MR2, after receiving a packet with the format illustrated in FIG. 13, determines if a value of the Addr[1] field 1350 having an index indicated by an LS field 1440 is identical to its own address, and if they are identical, generates again a tunneling packet.

When generating the packet, the MR2 copies an address in the Addr[2] field 1360, i.e., the next address of its index address stored in the Addr[1] field 1350 in the Addr list, to modify a DST field 1410 of FIG. 14, and generates a packet to be forwarded to an address in the DST field 1410. An SRC field 1400 of a packet transmitted from the MR2 to the MR3 is fixed to MR3_HA, and an address of the DST field 1410 is replaced with the MR3_CoA as described above. In addition, Type 2 in an RH field 1430 remains unchanged, and an LS field 1440 increases by 1. Further, an Addr[1] field 1450 and an Addr[2] field 1460 remain unchanged.

After receiving a packet with the format illustrated in FIG. 14 from the MR2, the MR3 detects MR3_CoA stored in the DST field 1410 of the received packet, and determines that the received packet is a packet targeting the MR3 itself. Thereafter, the MR3 analyzes Addr fields of the received packet, thereby recognizing that it is the last node in the Addr list as a result of the analysis, removes a tunneling header 1480 from the receive packet with the format illustrated in FIG. 14, and forwards an internal packet 1470 through general routing. Because the internal packet 1470 left after removing the tunneling header 1480 from the received packet is the packet originally generated by the CN, having an MN as its destination, the internal packet 1470 will be finally transmitted from the MR3 to the MN.

FIG. 15 is a diagram schematically illustrating a format of an NP option according to an embodiment of the present invention. Referring to FIG. 15, the NP option information includes a Type field 1500, a Length field 1510, an NP Length field 1520, and Addr fields 1530 to 1540. The Type field 1500 indicates that a type of the corresponding option is an NP option, the Length field 1510 indicates the total length of the option in bytes, and the NP Length field 1520 indicates the sum of lengths of the Addr fields 1530 to 1540 included in the NP option. Regarding the Addr fields 1530 to 1540, particular MRs insert their addresses into the Addr fields and transmit RA messages to their subnetworks together with the Addr fields. The higher level MR writes its address in the leading Addr field 1530, and the lower level MR writes its address in the following Addr field 1540. That is, an address written in the Addr[1] field is an address of the top level MR among the nested MRs, and an address of the Addr[n] is an address of the bottom level MR.

FIG. 16 is a diagram schematically illustrating a format of an NRP option according to an embodiment of the present invention. Referring to FIG. 16, the NRP option information includes a Type field 1620, a Length field 1630, an NP Length field 1600, a Reserved field 1610, and Addr fields 1640 to 1650. The Type field 1620 indicates that a type of the corresponding option is an NRP option, the Length field 1630 indicates the total length of the NRP option in bytes, and the NP Length field 1600 indicates the sum of lengths of the following Addr fields Addr[1] to Addr[n]. The Addr[1] field 1640 indicates address information of a router located in the top level among nested MRs collected through the NP option, and the Addr[n] field 1650 indicates address information of a router located in the bottom level among the nested MRs collected through the NR option.

FIG. 17 is a flowchart illustrating a procedure for generating NPI list information by an MR according to an embodiment of the present invention. Referring to FIG. 17, in step 1701, a particular MR receives an RA message from its higher level MR. In step 1703, the MR determines if an NP option is included in the received RA message. If an NP option is included in the received RA message, the MR proceeds to step 1705, where the MR stores an address list of the NP option in the above-stated manner. In step 1707, the MR increases an IDX field value by 1, and then proceeds to step 1715.

However, if it is determined in step 1703 that no NP option is included in the received RA message, in step 1709, because the MR receiving the RA message is a top level MR (TLMR), the MR determines that it is a top level MR. In step 1711, the MR generates a new NP option, and in step 1713, the MR stores its address as a top level MR address in an NP list of the generated NP option.

In step 1715, the MR writes its CoA in the NP list of the generated NP option, and in step 1717, the MR adds the generated NP option to a new RA message transmitted to its subnetwork. In step 1719, the MR transmits the NP option-added RA message to its subnetwork.

FIG. 18 is a flowchart illustrating a procedure for processing an NP option used for packet tunneling according to an embodiment of the present invention. Referring to FIG. 18, in step 1801, a particular MR receives a packet from its lower level node, and in step 1803, the MR determines if there is an NRP option in the received packet. If there is an NRP option in the received packet, in step 1805, the MR analyzes an Addr field corresponding to an index included in the NRP option. In step 1807, the MR determines if an address in the Addr field is identical to its own CoA. If the address included in the Addr field is not identical to its own CoA, the MR proceeds to step 1819, determining that the received packet is not a packet targeting the MR itself. In step 1819, the MR discards the received packet.

However, if it is determined in step 1807 that the address included in the Addr field is identical to its own address, in step 1809, the MR recognizes the received packet as a packet targeting the MR itself or its subnetwork and replaces a source address included in a tunneling header of the packet with its own CoA. In step 1811, the MR reduces an IDX field value included in the tunneling header by 1, and in step 1813, the MR determines if the reduced IDX field value is ‘0’ (IDX=0). If IDX=0, in step 1815, the MR recognizes that it is a top level MR (TLMR). In step 1817, the MR directly transmits the packet to a destination address included in a tunneling header of the received packet.

However, if it is determined in step 1813 that the reduced index field value is not ‘0’, in step 1831, because the MR is not a top level MR, the MR transmits the packet to its higher level MR.

If it is determined in step 1803 that no NRP option is included in the packet received from its lower level node, in step 1821, the MR recognizes that it is a bottom level MR. In step 1823, the MR generates a new tunneling header, and in step 1825, the MR generates an NP option. In step 1827, the MR generates an NPI list for the generated NP option, and in step 1829, the MR stores information on the number of addresses in the NPI list as a value of the IDX field. In step 1831, the MR transmits a new packet with the generated tunneling header to its higher level MR.

As can be understood from the foregoing description, an MR selects an optimized path using nested path information and safely transmits packets to an HA through an extended BU message including information on the selected path, thereby providing an optimized tunnel between the MR and the HA. By using the optimized tunnel, the packets are forwarded via the optimized path. In addition, by protecting nested path information with an authentication header, it is possible to avoid a security-jeopardizing factor such as a spoofing attack, which may be made in intermediate nodes. Accordingly, the present invention provides optimized routing and secures security. In addition, the present invention reduces packet transmission and overhead in a nested NEMO environment.

While the present invention has been shown and described with reference to certain preferred embodiments thereof, it will be understood by those skilled in the art that various changes in form and details may be made therein without departing from the spirit and scope of the present invention as defined by the appended claims.

1. A method for optimizing a tunnel between a second mobile router and a home agent of the second mobile router in a mobile network having a nested structure in which a first mobile router manages a subnetwork including at least the second mobile router, and the second mobile router manages a subnetwork including at least one node, the method comprising the steps of:
receiving, by the second mobile router, nested path information from the first mobile router;
transmitting, by the second mobile router, the nested path information to the home agent of the second mobile router via the first mobile router; and
storing, by the home agent of the second mobile router, the nested path information received from the second mobile router.

2. The method of claim 1, wherein the nested path information transmitted by the first mobile router is transmitted through a routing advertisement message.

3. The method of claim 1, wherein the nested path information transmitted by the second mobile router is included in a header created for tunneling, the header being included in a packet transmitted by the second mobile router.

4. The method of claim 3, wherein the header created for tunneling includes source information and destination information of a transmission packet.

5. The method of claim 3, wherein the header created for tunneling includes index information based on which a mobile router transmitting the packet can determine how many mobile routers are located in its higher levels.

6. A method for transmitting packet data from a second mobile router to a node located outside a first mobile router in a mobile network having a nested structure in which the first mobile router manages a subnetwork including at least the second mobile router, and the second mobile router manages a subnetwork including at least one node, the method comprising the steps of:
tunneling between the second mobile router and a home agent of the second mobile router;
adding, by the second mobile router, a tunneling header including the nested path information to a transmission packet;
transmitting, by the second mobile router, the transmission packet to the first mobile router;
receiving, by the first mobile router, the packet transmitted from the second mobile router;
analyzing, by the first mobile router, the nested path information in the received packet; and
transmitting, by the first mobile router, the packet to the home agent of the second mobile router.

7. The method of claim 6, the step of tunneling between the second mobile router and a home agent of the second mobile router comprises:
detecting, by the second mobile router, a nested path through nested path information received from the first mobile router; and
transmitting, by the second mobile router, the nested path information to a home agent of the second mobile router.

8. The method of claim 6, wherein the first mobile router transmits its temporary address information through a routing advertisement message.

9. The method of claim 6, wherein the nested path information transmitted by the second mobile router is included in a header created for tunneling, the header being included in a packet transmitted by the second mobile router.

10. The method of claim 9, wherein the header created for tunneling includes source information and destination information of a transmission packet.

11. The method of claim 9, wherein the header created for tunneling includes index information based on which a mobile router transmitting the packet can determine how many mobile routers are located in its higher levels.

12. The method of claim 6, further comprising the step of transmitting, by the home agent of the second mobile router, the received packet to the node located outside the first mobile router.

13. A method for transmitting packet data from a node located outside a first mobile router to a second mobile router in a mobile network having a nested structure in which the first mobile router manages a subnetwork including at least the second mobile router, and the second mobile router manages a subnetwork including at least one node, the method comprising the steps of:
tunneling between the second mobile router and a home agent of the second mobile router;
receiving, by the home agent, packet data from a node located outside the first mobile router;
analyzing nested path information from the second mobile router stored in the home agent of the second mobile router by the home agent;
adding, by the home agent, a tunneling header including nested path information from the second mobile router to a transmission packet;
transmitting, by the home agent, the transmission packet to the first mobile router;
receiving, by the first mobile router, a packet transmitted from the home agent of the second mobile router;
analyzing, by the first mobile router, nest path information in a header of the received packet; and
transmitting, by the first mobile router, the packet to the second mobile router.

14. The method of claim 13, the step of tunneling between the second mobile router and a home agent of the second mobile router comprises:
detecting, by the second mobile router, a nested path through nested path information received from the first mobile router;
transmitting, by the second mobile router, the nested path information to a home agent of the second mobile router.

15. The method of claim 13, wherein the nested path information transmitted by the first mobile router is transmitted through a routing advertisement message.

16. The method of claim 13, wherein the nested path information transmitted by the second mobile router is included in a header created for tunneling, the header being included in a packet transmitted by the second mobile router.

17. The method of claim 16, wherein the header created for tunneling includes source information and destination information of a transmission packet.

18. The method of claim 16, wherein the header created for tunneling includes index information base on which a mobile router transmitting the packet determines how many mobile routers are located in its higher levels.
